(19) United States
(12) Patent Application Publication
(10) Pub. No.: US 2019/0238958 A1
(43) Pub. Date: Aug. 1, 2019

(54) STOVE SENSOR

(71) Applicant: The Chamberlain Group, Inc., Oak Brook, IL (US)

(72) Inventor: Nathan J. Kopp, Fremont, CA (US)

(21) Appl. No.: 15/883,010

(22) Filed: Jan. 29, 2018

(51) Int. Cl. H04Q 9/02; H04L 29/08; G08B 7/06; G01J 5/00; G01J 5/02; F24C 7/08

(52) U.S. Cl. CPC H04Q 9/02; H04L 67/12; G08B 7/06; H04M 1/72533; G01J 5/025; G01J 5/0285; F24C 7/08; G01J 5/0044

(57) ABSTRACT

A stove sensor system includes a non-contact infrared detector, a memory, a microcontroller unit and a communication module. The microcontroller unit runs a monitoring algorithm that receives input from the ambient temperature sensor and the non-contract infrared detector and stores tracking information within the memory. The communication module communicates to a cloud server to provide to the cloud server tracking information and alert information produced by the monitoring algorithm run by the microcontroller unit.

### BACKGROUND

Stove sensors can be used for safety and convenience. For example, the INIRV REACT monitoring device provides remote monitoring and control of stove knobs. It senses that the stove is “on” by detecting the position of the stove control knob. The IGUARDSTOVE automatic stove shutoff device is designed to disable the stove when an elderly operator is not present. It senses that the stove is “on” by measuring current flowing to the stove through AC power supplied to the stove.

Smart Stoves, such as the SAMSUNG NX58K9850SS double oven gas range provide built-in technology to connect the stove to Smartphones through the cloud, allowing the user to monitor and control stove functions. The INNOHOME Stove Alarm SA101 is a stove alarm that detects dangerous (high-temperature) stove conditions and sounds a local warning alarm.

### BRIEF DESCRIPTION OF THE DRAWINGS

FIG. 1 is a simplified block diagram of a stove sensor system in accordance with an implementation.

FIG. 2 is a simplified block diagram of an extended communication options available to a stove sensor system in accordance with an implementation.

FIG. 3, FIG. 4 and FIG. 5 are simplified block diagrams that show examples of different configurations of stove sensor systems.

FIG. 6 is a simplified block diagram that shows a cloud implementation ecosystem connecting stove sensors, human presence detectors, smartphones, and computers.

FIG. 7 is a simplified block diagram that shows an implementation of a wireless alert module for a stove sensor system.

### DETAILED DESCRIPTION

A stove sensor system employs non-contact temperature sensors, such as single-pixel infrared sensors, a coarse pixel grid of infrared sensors, or infrared cameras, to detect the temperature of a stove surface situated within a detection coverage range. Additional devices within the stove sensor system are used to monitor the environment and provide additional information. The detection coverage range is defined by a cone-shaped volume emanating from mounted sensor heads. For example, an ambient temperature sensor is used to perform comparison of the stove surface temperature against the ambient air temperature. An optional humidity sensor is used, for example, to perform detection of water boiling. An optional visible light camera is present to take snapshot images of the stove surface.

The stove sensor system is connected to a cloud network through a WiFi connection, an LTE cellular service or some other networking technology. Temperature and humidity data is stored, for example, in cloud-based servers. A smartphone based mobile app can be operated by a user to track and display current status and trend data, and to receive event alert notifications. An optional hardware wireless alert module can also be used to display status and alerts.

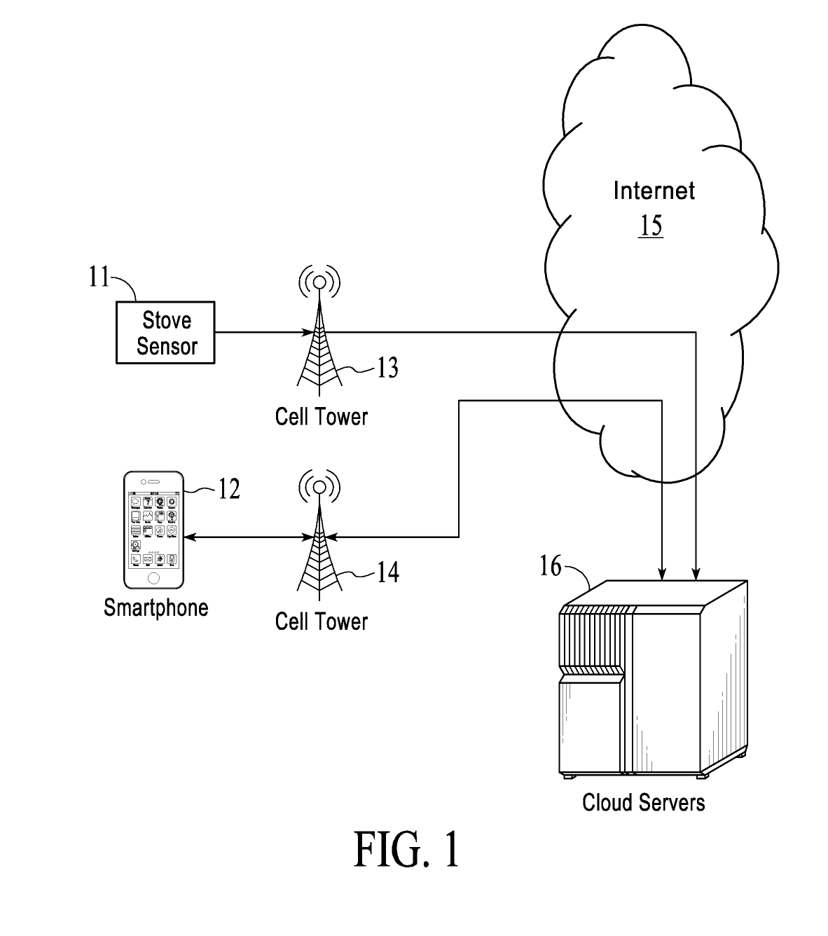

FIG. 1 shows a stove sensor system 11 and a smart phone 12 connected through the Internet 15 to cloud servers 16. Cell tower 13 and cell tower 14 represent the cellular network(s) used by stove sensor system 11 and smart phone 12 to connect to the Internet 15. Smart phone 12 is representative of any portable device a user may possess that is able to communicate through the Internet 15 with cloud servers 16.

FIG. 1 shows a stove sensor system 11 and a smart phone 12 connected through the Internet 15 to cloud servers 16. Cell tower 13 and cell tower 14 represent the cellular network(s) used by stove sensor system 11 and smart phone 12 to connect to the Internet 15. Smart phone 12 is representative of a portable device a user may possess that is able to communicate through the Internet 15 with cloud servers 16.

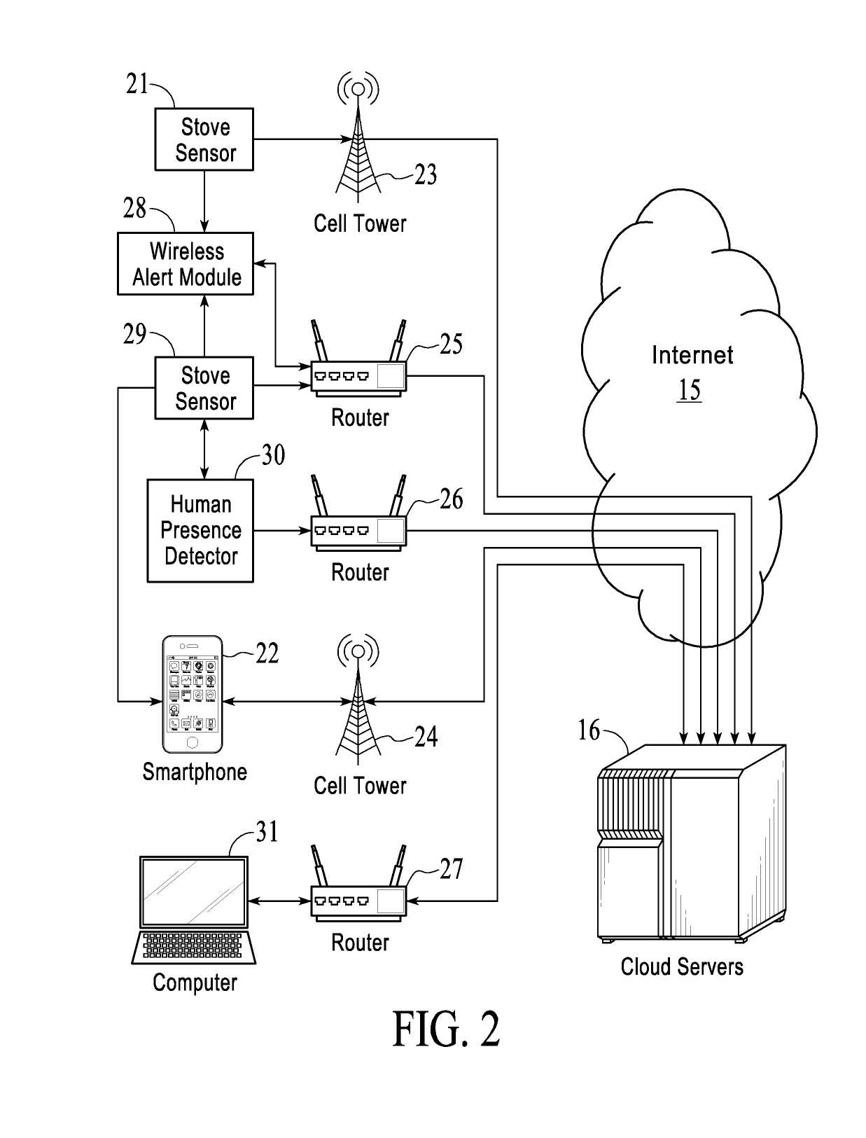

FIG. 2 illustrates various potential communication paths between a stove sensor system 21, a wireless alert module 28, a stove sensor 29, a human presence detector 30, a smart phone 22 and a computer 31. For example, stove sensor system 21, wireless alert module 28, stove sensor 29, human presence detector 30, smart phone 22 and computer 31 can communicate via connections through the Internet 15 to cloud servers 16. Cell tower 23 and cell tower 24 represent the cellular network(s) that can be used for these interconnections. Likewise, a router 25, a router 26 and a router 26 represent WiFi, Ethernet or other local area network connections that can be used for these interconnections. In addition, stove sensor system 21, wireless alert module 28, stove sensor 29, human presence detector 30, smart phone 22 and computer 31 can communicate directly with each other through local area networks and other local connections, such as, for example, Ethernet, WiFi, LoRa, Bluetooth or other similar networks and networking protocols. Smart phone 12 is representative of a portable computing device a user may possess that is able to communicate through the Internet 15 with cloud servers 16.

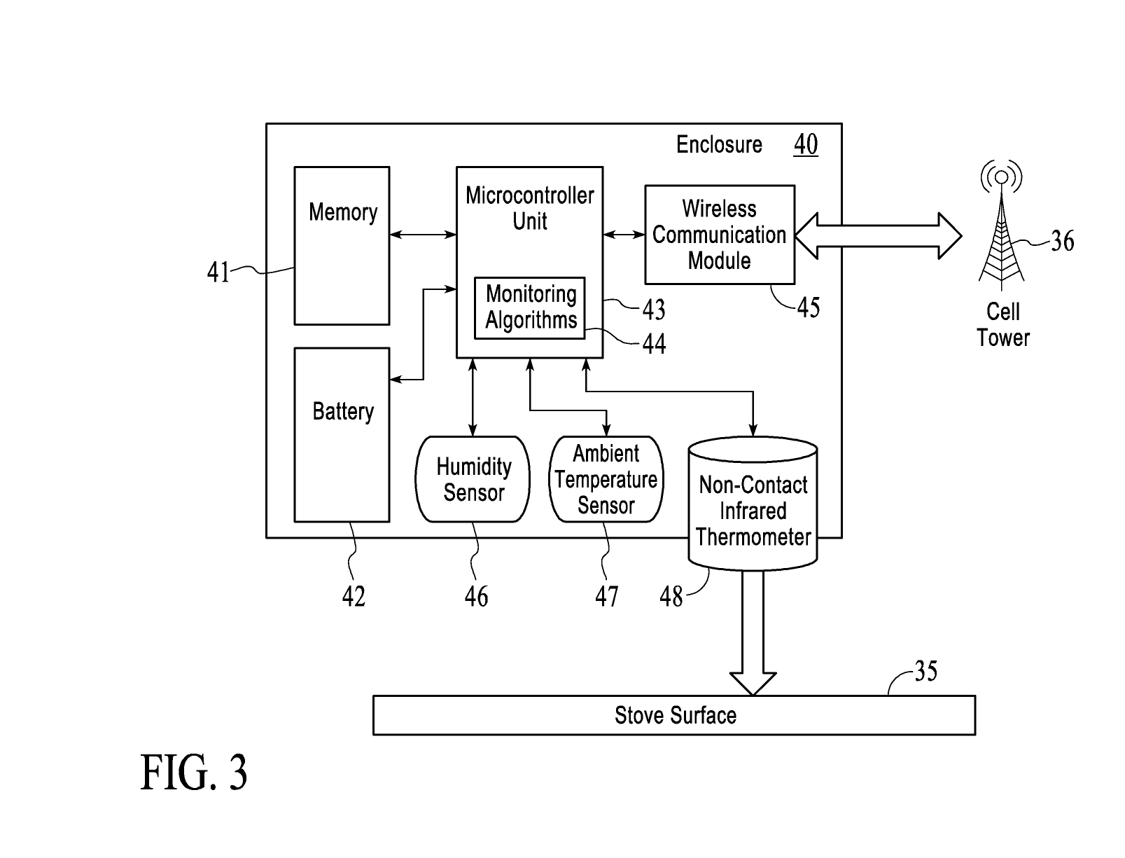

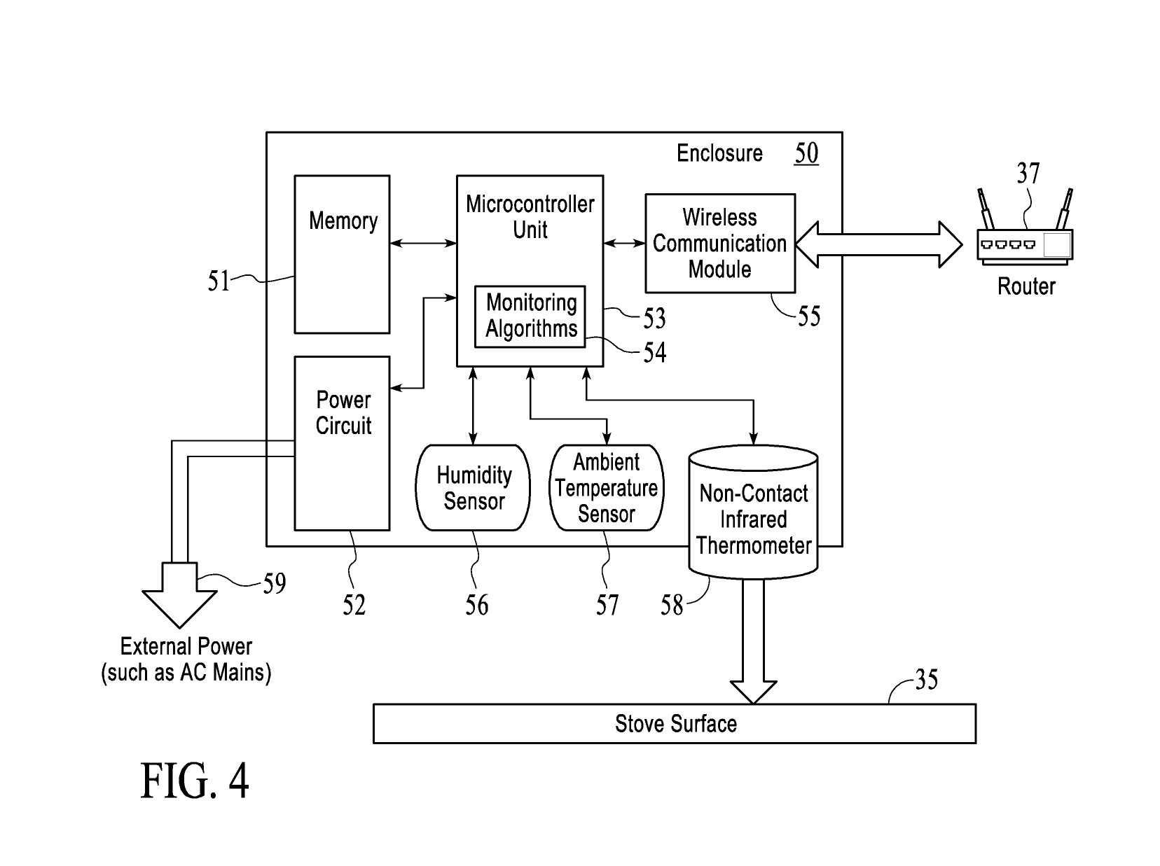

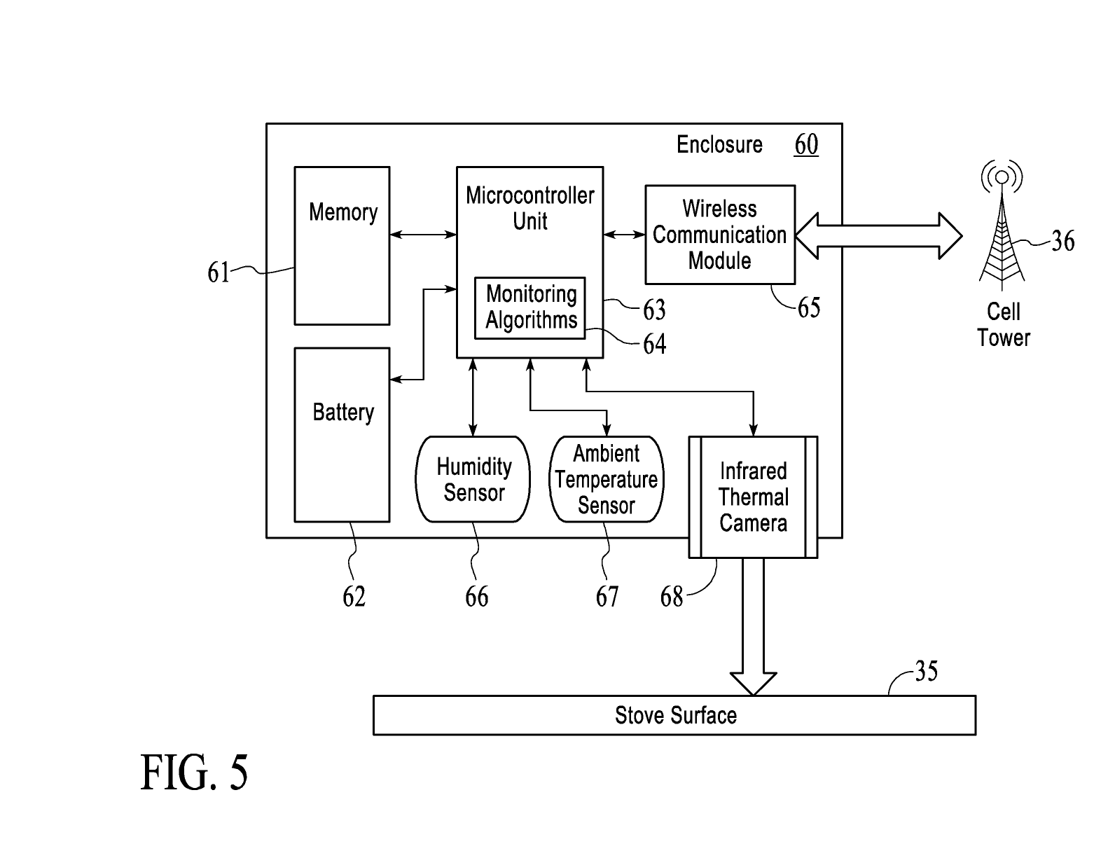

FIG. 3 shows an implementation where a stove sensor system 40 includes a memory 41, a battery 42, a microcontroller unit 43 a wireless communication module 45 a humidity sensor 46, an ambient temperature sensor 47 and a non-contact infrared thermometer 48. For example, wireless communication module 45 connects with a cellular service such as a cellular LTE service, represented by a cell tower 36. Alternatively, or in addition, wireless communication module 45 allows communication using other wired or wireless protocols such as Ethernet, WiFi, LoRa, Bluetooth or other similar protocols. Monitoring algorithms 44 running on microcontroller unit 43 monitor values from humidity sensor 46, ambient temperature sensor 47 and non-contact infrared thermometer 48 for the purpose of tracking and alerts. Humidity sensor 46, ambient temperature sensor 47 and non-contact infrared thermometer 48 are situated in relation to a stove surface 35 to allow monitoring of stove surface 35, including items placed on stove surface 35.

For example, non-contact infrared thermometer 48 is a non-contact infrared detector that is composed of one or a combination of a single-pixel infrared sensor, a coarse pixel grid infrared sensor, or an infrared camera used to detect temperature of stove surface 35 as situated within a detection coverage range that is defined by a cone-shaped volume emanating from mounted sensor heads for non-contact infrared thermometer 48.

For example, non-contact infrared thermometer 48 can be mounted conveniently in various locations relative to the stove surface 35 and a stove hood. For example, non-contact infrared thermometer 48 can be mounted on a wall behind stove surface 37, mounted inside a hood above stove surface 37, built into a stove hood for stove surface 37 or mounted on a stand beside stove surface 37.

Non-contact infrared thermometer 48 can be implemented, for example, by a low-cost single-pixel infrared sensor such as the MELEXIS MLX90614 temperature sensor, by a medium-cost sensor with a grid of coarse pixels such as the PANASONIC Grid-EYE 8×8 temperature sensor or by a higher cost infrared camera such as a FLIR Lipton camera.

For example, microcontroller unit 43 is a microcontroller (MCU) or Central Processing Unit (CPU) used to analyze sensor data and generate and store short-term and long-term trends databases within memory 41 and or remotely in a cloud server. For example, when sensor data is stored remotely, memory 41 can be used to initially store the sensor data between the time the sensor data is received by microcontroller unit 43 from the various sensors and the time the sensor data is sent to be stored remotely.

For example, ambient temperature sensor 47 is present to perform comparison of the stove surface temperature against the ambient air temperature.

For example, optional humidity sensor 46 is used to perform detection of water boiling. For example, an optional visible light camera can be used to take snapshot images of stove surface 35.

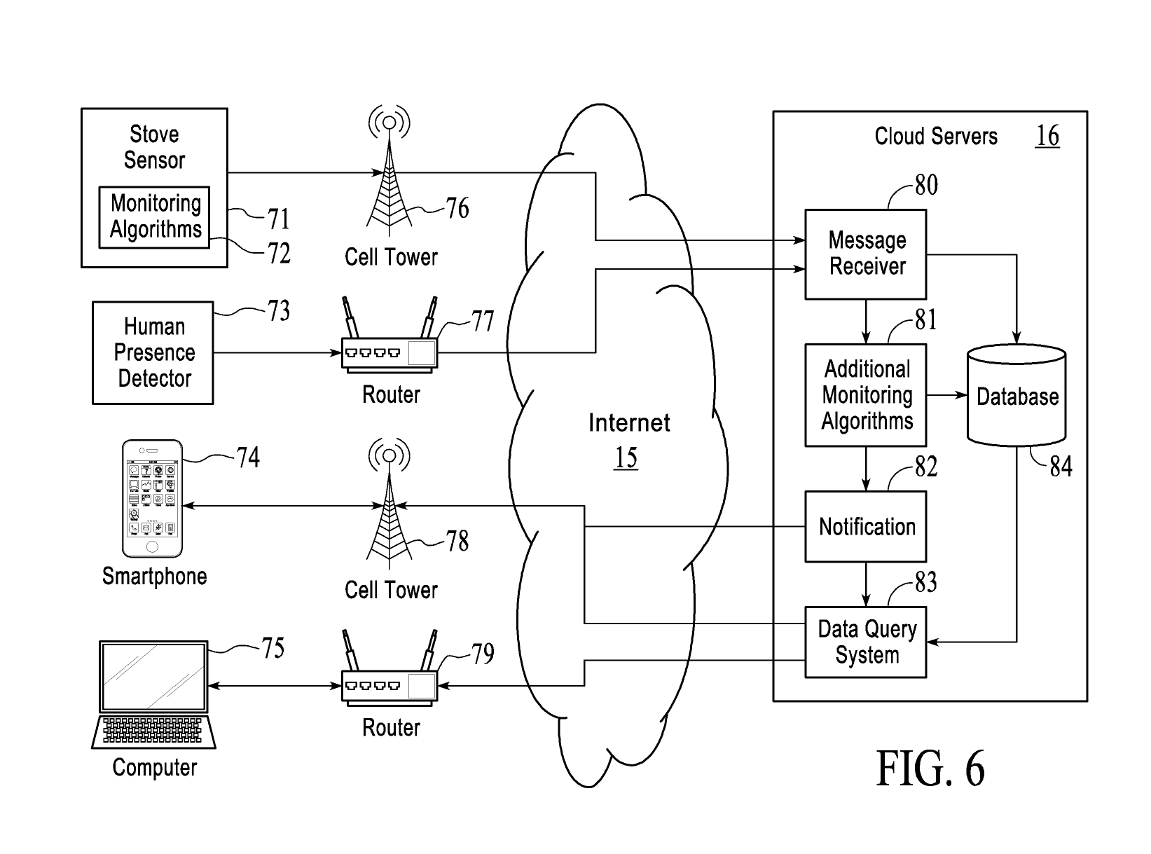

An optional human presence sensor 73 (shown in FIG. 6) can be included internally or externally to stove sensor system 40. Human presence sensor 73 includes detection logic that triggers a warning (alert) of an ‘unattended stove’ situation when nobody is near stove surface 35 for a preset human-absence warning interval.

FIG. 4 shows an implementation where a stove sensor system 50 includes a memory 51, a power circuit 52, a microcontroller unit 53 a wireless communication module 55 a humidity sensor 56, an ambient temperature sensor 57 and a non-contact infrared thermometer 58. For example, wireless communication module 55 communicates using a wireless or wired protocol such as Ethernet, WiFi, LoRa, Bluetooth or other similar protocols. This is illustrated, for example, by the presence of a router 37 in FIG. 4. Monitoring algorithms 54 running on microcontroller unit 53 monitor values from humidity sensor 56, ambient temperature sensor 57 and non-contact infrared thermometer 58 for the purpose of tracking and alerts. Humidity sensor 56, ambient temperature sensor 57 and non-contact infrared thermometer 58 are situated in relation to stove surface 35 to allow monitoring of stove surface 35, including items placed on stove surface 35.

FIG. 5 shows an implementation where a stove sensor system 60 includes a memory 61, a battery 62, a microcontroller unit 63 a wireless communication module 65 a humidity sensor 66, an ambient temperature sensor 67 and an infrared thermal camera 68. For example, wireless communication module 65 connects with a cellular service such as a cellular LTE service, represented by a cell tower 36. Alternatively, or in addition, wireless communication module 65 allows communication using other wired or wireless protocols such as Ethernet, WiFi, LoRa, Bluetooth or other similar protocols. Monitoring algorithms 64 running on microcontroller unit 63 monitor values from humidity sensor 66, ambient temperature sensor 67 and infrared thermal camera 68 for the purpose of tracking and alerts. Humidity sensor 66, ambient temperature sensor 67 and infrared thermal camera 68 are situated in relation to a stove surface 35 to allow monitoring of stove surface 35, including items placed on stove surface 35.

FIG. 6 shows a cloud implementation ecosystem with a collection of full-capability cloud servers, connecting all of stove sensors, human presence detectors, Smartphones, computers and so on. For example, a stove sensor system 71, a human presence detector 73, a smart phone 74 and a computer 75 communicate via connections through the Internet 15 to cloud servers 16. Cell tower 76 and cell tower 77 represent the cellular network(s) that can be used for these interconnections. Likewise, a router 77 and a router 79 represent WiFi or Ethernet connections that can be used for these interconnections. As discussed above communication can also be implemented through local area networks and other local connections, such as, for example, Ethernet, WiFi, LoRa, Bluetooth or other similar networks and networking protocols. For example, stove sensor system 71 utilizes monitoring algorithms 72, as discussed above and includes some combination of one or more humidity sensors, ambient temperature sensors, non-contact infrared thermometers, infrared thermal cameras and visible light cameras to monitor a stove surface and ambient temperature used to monitor a stove, as exemplified by various implementations stove sensor systems described above.

Cloud servers 60 includes, for example, a message receiver 80, additional monitoring algorithms 81, a notification module 82, a data query system 83 and a database 84. For example, temperature and humidity data is stored in database 84. For example, monitoring algorithms 81 allow cloud servers 61 to continually analyze data from stove sensors to determine if a stove is on, and whether water is boiling. The results generated by monitoring algorithms 81 are stored along with trend data in database 84.

Monitoring algorithms 72 run on a microcontroller within stove sensor system 71, allowing for operation while stove sensor system 71 is not connected to cloud servers 16. Stove sensor system 71 is able to notify smartphone 74 or a Wireless Alert Module directly using WiFi, Bluetooth, LoRA, or a similar wireless protocol, instead of using cloud-based communication.

A smartphone mobile app within smartphone 74 operated by a user can display trend data and receive and respond to event alert notifications. When the mobile app detects that the user has left the residence, for example via human presence detector 73, the mobile app will check with stove sensor system 71 to see whether sensors within stove sensor system 71 detect that the stove once left on. If so, the mobile app will notify the user of the potentially dangerous situation.

When the Monitoring Algorithms have detected boiling, the stove sensor system 71 will notify the user's smartphone 74. Stove sensor system 71 can also communicate with a wireless alert module, as described above, which is an additional wireless device that can indicate visual and audio alerts.

If stove sensor system 71 includes a visible light camera, the user can see an up-to-date image of the stove for visual confirmation. For example, a visible light camera allows stove sensor to automatically capture one or more photos of each meal that is cooked on the stove, capturing photos at an interval or intervals after detecting “stove on” and “boiling” events.

For example, if a pixel-grid sensor is used, stove sensor system 71 can be used to measure the surface temperature of cooking food. This will allow stove sensor system 71 to be integrated with a cooking app on a smartphone, tablet, or other computing device to perform functions such as notifying a user if the surface temperature exceeds what is recommended for the chosen recipe, measuring an amount of time that the stove is on or that the food is at a specific temperature. This allows, for example, stove sensor system 71 to automatically notify a user when a time limit has been reached.

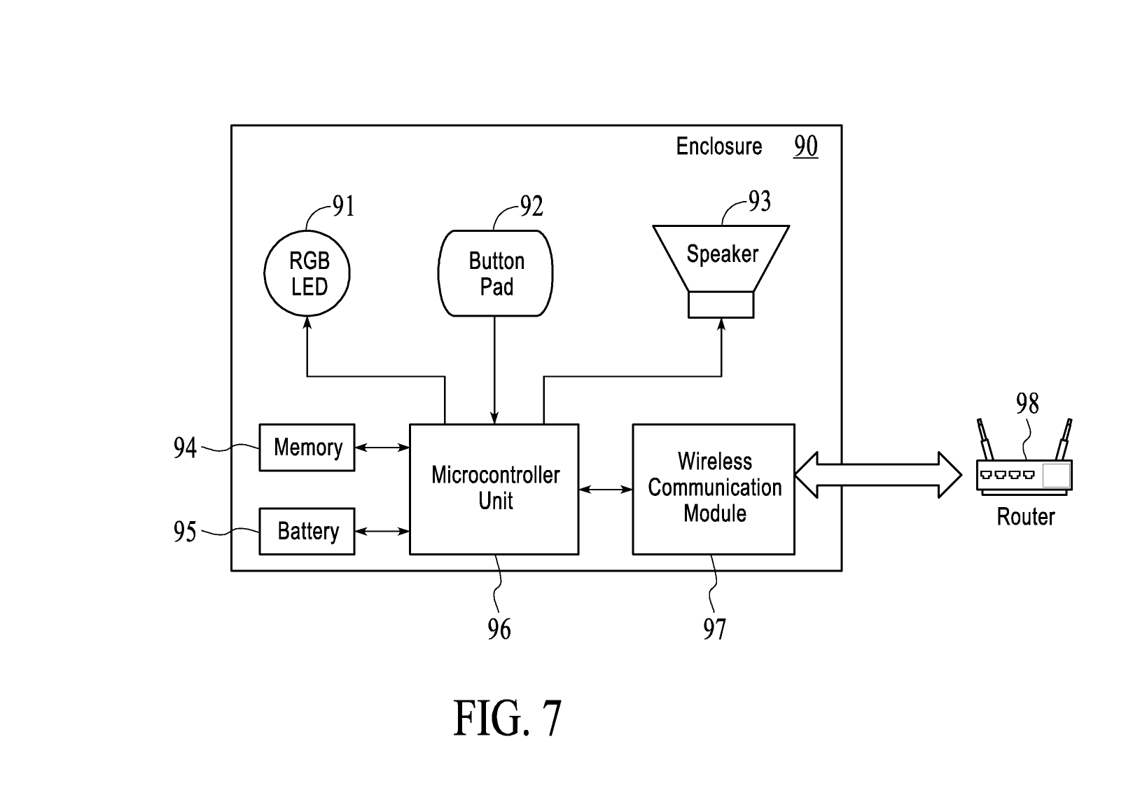

FIG. 7 shows an implementation of a wireless alert module 90. For example, wireless alert module is powered by a battery 95 and is connected to a WiFi router 98. An RGB LED 91 and a speaker 93 are used to indicate status of a stove. A button pad 92 allows an operator to silence speaker 93 and turn off RGB LED 91, as well as to adjust an automatic timer. For example, wireless alert module 90 also includes a memory 94, a microcontroller unit 96 and a wireless communication module 97.

For example, stove sensor system 71 can be configured to automatically start a countdown timer when the stove is turned on, using a preset duration determined in advance by a user. The user is notified that the timer has started. The user may change the duration using the smartphone app or buttons on button pad 92 of wireless alert module 90. When the timer expires, a user's smartphone and wireless alert module 90s provide notifications to the user. For example, stove sensor system 71 may be configured so that the notification will continue to repeat until stove sensor system 71 detects that the stove has been turned off or until a user manually cancels the notification.

For example, when stove sensor system 71 is integrated within a larger ecosystem, such as the TEND-INSIGHT IoT ecosystem, various across-system alerts and integrated services and applications can be supported. For example, if the ecosystem detects a situation where the stove is on but the residents are all away (for example, by using geo-location, computer vision people detection, passive infrared sensor technology, or another method occupancy sensing), the ecosystem can alert all users of the dangerous situation.

For example, stove sensor system 71 can be integrated with food delivery services (such as BLUE APRON, HOME CHEF, and HELLO FRESH home delivery services) to provide users with additional help in cooking delivered meals. For example, to implement this, sensor 71 includes a pixel-grid sensor or a thermal camera that allow for more detailed temperature readings.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

1. A stove sensor system comprising:
an enclosure configured for placement at a location apart from and above a stove surface;
an ambient temperature sensor, housed by the enclosure, that measures ambient temperature of air around the enclosure;
a non-contact infrared detector, housed by the enclosure, that from the location apart from and above the stove surface detects temperature at the stove surface;
memory within the enclosure;
a microcontroller unit, within the enclosure, running a monitoring algorithm that receives input from the ambient temperature sensor and the non-contract infrared detector and stores tracking information within the memory, the monitoring algorithm additionally comparing the ambient temperature of the air around the enclosure, as measured by the ambient temperature sensor, with the temperature at the stove surface, as measured by the non-contact infrared detector; and,
a communication module, within the enclosure, that communicates to a cloud server to provide to the cloud server tracking information and alert information produced by the monitoring algorithm run by the microcontroller unit.

2. A stove sensor system as in claim 1, wherein the non-contact infrared detector is a non-contact infrared thermometer.

3. A stove sensor system as in claim 1, wherein the non-contact infrared detector is an infrared thermal camera.

4. A stove sensor system as in claim 1, additionally comprising a humidity sensor.

5. A stove sensor system as in claim 1, additionally comprising a visible light camera.

6. A stove sensor system as in claim 1, additionally comprising a human presence detector.

7. A stove sensor system as in claim 1, additionally comprising remote monitoring algorithms that run on the cloud server.

8. A stove sensor system as in claim 1, wherein the communication module communicates to the cloud server using a cellular network.

9. A stove sensor system as in claim 1, wherein the communication module communicates to the cloud server using wireless communication to a router.

10. A stove sensor system as in claim 1, wherein the communication module additionally provides wireless communication to a local computing device.

11. A stove sensor system as in claim 1, additionally comprising a wireless alert module, the wireless alert module receiving alert signals from the communication module and provides alerts to a user local to the wireless alert module.

12. A stove sensor system as in claim 1, additionally comprising a wireless module, the wireless module including:
a wireless communication module to receive alert signals transmitted by the communication module;
a speaker that provides an alert sound; and,
a light that produces an optical alert signal.

13. A stove sensor system comprising:
an enclosure configured for placement at a location apart from and above a stove surface;
a humidity sensor, housed by the enclosure, that measures humidity of air around the enclosure allowing detection of water boiling from heat generated at the stove surface;
a non-contact infrared detector, housed by the enclosure, that from the location apart from and above the stove surface detects temperature at the stove surface;
memory within the enclosure;
a microcontroller unit, within the enclosure, running a monitoring algorithm that receives input from the humidity sensor and the non-contract infrared detector and stores tracking information within the memory; and,
a communication module, within the enclosure, that communicates to a cloud server to provide to the cloud server tracking information and alert information produced by the monitoring algorithm run by the microcontroller unit, the alert information including an alert when the humidity sensor detects water boiling from heat generated at the stove surface.

14. A stove sensor system as in claim 13, wherein the non-contact infrared detector is a non-contact infrared thermometer or an infrared thermal camera.

15. A stove sensor system as in claim 13, additionally comprising a visible light camera.

16. A stove sensor system as in claim 13, additionally comprising a human presence detector.

17. A stove sensor system as in claim 13, additionally comprising remote monitoring algorithms that run on the cloud server.

18. A stove sensor system as in claim 13, wherein the communication module additionally provides wireless communication to a local computing device.

19. A stove sensor system as in claim 13, additionally comprising a wireless alert module, the wireless alert module receiving alert signals from the communication module and provides alerts to a user local to the wireless alert module.

20. A stove sensor system as in claim 13, additionally comprising a wireless module, the wireless module including:
a wireless communication module to receive alert signals transmitted by the communication module;
a speaker that provides an alert sound; and,
a light that produces an optical alert signal.
